(19) United States
(12) Patent Application Publication
(10) Pub. No.: US 2013/0114709 A1
(43) Pub. Date: May 9, 2013

(54) IMAGE CODING APPARATUS, IMAGE CODING METHOD, IMAGE DECODING APPARATUS, IMAGE DECODING METHOD, AND STORAGE MEDIUM

(71) Applicant: CANON KABUSHIKI KAISHA, Tokyo (JP)

(72) Inventor: Masato Shima, Tokyo (JP)

(73) Assignee: CANON KABUSHIKI KAISHA, Tokyo (JP)

(21) Appl. No.: 13/667,881

(22) Filed: Nov. 2, 2012

(30) Foreign Application Priority Data
Nov. 7, 2011 (JP) 2011-243941
Jan. 19, 2012 (JP) 2012-009304

(51) Int. Cl. H04N 7/32

(52) U.S. Cl. 375/240.12; 375/E07.243

(57) ABSTRACT

An image coding apparatus includes a quantization matrix coding unit configured to code quantization matrices, wherein the quantization matrix coding unit is configured to code a difference between a coefficient to be coded and a coefficient adjacent to the coefficient to be coded, and to use, when coding the difference having a positive value, a coding table that uses a code of a bit number equal to or less than that of a code used to code the difference having a negative value having the same absolute value as the absolute value of the positive value.

### BACKGROUND OF THE INVENTION

1. Field of the Invention

The present invention relates to an image coding apparatus, an image coding method, an image decoding apparatus, an image decoding method, and a storage medium. More particularly, the present invention relates to a coding/decoding method of a quantization matrix in an image.

2. Description of the Related Art

As a compression recording standard of a moving image, there is known H.264/MPEG-4 AVC (hereinafter referred to as H.264). (ITU-T H.264 (March 2010) Advanced video coding for generic audiovisual services) Regarding H.264, each element of a quantization matrix can be changed into an arbitrary value by coding scaling list information. According to chapter 7.3.2.1.1.1 of H.264, by adding a delta scale being a difference value between an element and the previous element, each element of the quantization matrix can take an arbitrary value.

Regarding H.264, a delta scale, which is the above-described difference value, is coded by a method called signed Exp-Golomb coding illustrated in FIG. 5A. For example, if the difference between an element in the matrix and its previous element is 0, a binary code 1 is coded. If the difference is −2, a binary code 00101 is coded. According to this coding method, the length of the binary code is increased as the absolute value of the value to be coded is increased. Thus, regardless of whether the difference value is a negative value or a positive value, if they have the same absolute value, they have the same code length.

Further, regarding H.264, elements of the quantization matrix are scanned in the direction from the element at the upper left corner of the two-dimensional quantization matrix, which corresponds to a low frequency component, to the element at the bottom right corner, which corresponds to a high frequency component. Generally, in performing image coding, elements corresponding to low frequency components are reduced and elements corresponding to high frequency components are increased so that they match the visual feature of the user. Thus, the value of the element of the scanned quantization coefficient at the lower right is greater than the value of the element at the upper left. Thus, regarding the difference between an element to be coded and its previous element, the probability of the difference being a positive value is higher than the probability of the difference being a negative value.

However, since the code length of the positive value of the signed Exp-Golomb code used in H.264 is equal to that of the negative value, the amount of code of the quantization matrix will be increased.

### SUMMARY OF THE INVENTION

The present invention relates to realizing high efficiency quantization matrix coding/decoding by introducing a coding method of plus-minus asymmetry to coding of a quantization matrix.

According to an aspect of the present invention, an image coding apparatus includes a block division unit configured to divide an input image into a plurality of blocks, a prediction unit configured to perform prediction using coding-completed pixels to generate prediction errors, a transformation unit configured to perform orthogonal transform to the prediction errors to generate transform coefficients, a quantization matrix generation unit configured to generate quantization matrices that are used to quantize the transform coefficients, a quantization matrix coding unit configured to code the quantization matrices, a quantization unit configured to scan the generated transform coefficients and to quantize the transform coefficients using the quantization matrices to generate quantization coefficients, and a coefficient coding unit configured to code the quantization coefficients, wherein the quantization matrix coding unit is configured to code a difference between a coefficient to be coded and a coefficient adjacent to the coefficient to be coded, and to use, when coding the difference having a positive value, a coding table that uses a code of a bit number equal to or less than that of a code used to code the difference having a negative value having the same absolute value as the absolute value of the positive value.

According to an exemplary embodiment of the present invention, the amount of code for quantization matrix coding can be reduced, and high efficiency quantization matrix information coding/decoding becomes possible.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image coding apparatus according to a first and a fifth exemplary embodiment of the present invention.

FIG. 2 is a block diagram illustrating a configuration of an image decoding apparatus according to a second and a sixth exemplary embodiment of the present invention.

FIG. 3 is a block diagram illustrating a configuration of the image coding apparatus according to a third exemplary embodiment of the present invention.

FIG. 4 is a block diagram illustrating a configuration of the image decoding apparatus according to a fourth exemplary embodiment of the present invention.

FIGS. 5A and 5B illustrate coding tables of plus-minus symmetry and plus-minus asymmetry, respectively.

FIGS. 6A and 6B illustrate an example of a quantization matrix.

FIG. 7 illustrates a coding example of the quantization matrix.

FIGS. 8A and 8B illustrate examples of a bit stream structure.

FIG. 9 is a flowchart illustrating image coding processing of the image coding apparatus according to the first and the fifth exemplary embodiment.

FIG. 10 is a flowchart illustrating image decoding processing of the image decoding apparatus according to the second and the sixth exemplary embodiment.

FIG. 11 is a flowchart illustrating image coding processing of the image coding apparatus according to the third exemplary embodiment.

FIG. 12 is a flowchart illustrating image decoding processing of the image decoding apparatus according to the fourth exemplary embodiment.

FIG. 13 is a block diagram illustrating a configuration example of hardware of a computer applicable to the image coding apparatus and the decoding apparatus according to the exemplary embodiments of the present invention.

FIGS. 14A and 14B illustrate examples of a plus-minus asymmetry coding table according to a fifth and a sixth exemplary embodiments.

FIGS. 15A and 15B illustrate examples of a table used for mapping a positive/negative value to a positive index.

FIGS. 16A and 16B illustrate examples of a coding table corresponding to a positive index.

FIG. 17 illustrates a coding example of the quantization matrix according to the fifth and the sixth exemplary embodiments.

### DESCRIPTION OF THE EMBODIMENTS

Various exemplary embodiments, features, and aspects of the invention will be described in detail below with reference to the drawings.

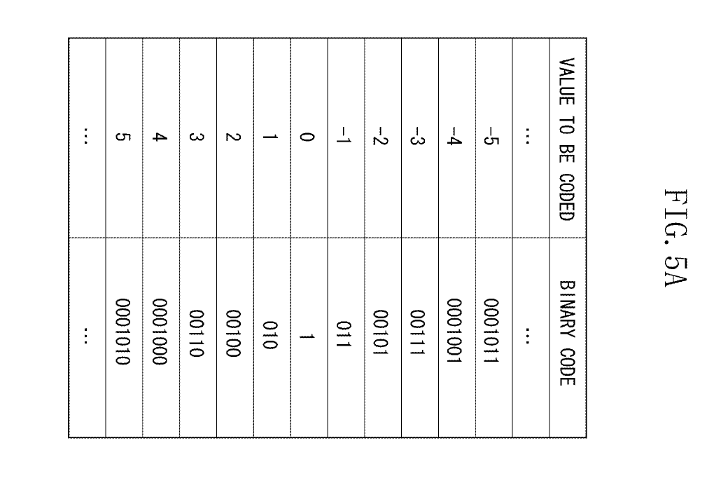

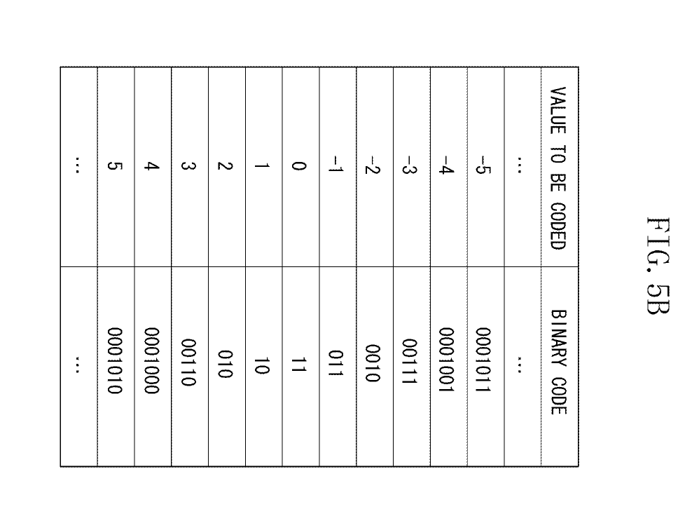

In the context of the present specification, a coding method that provides a shorter code length for a positive value than a negative value if the positive value and the negative value have the same absolute value is called a plus-minus asymmetry coding method. Further, a coding table used for the plus-minus asymmetry coding is called a plus-minus asymmetry coding table, and a decoding table used for the plus-minus asymmetry decoding is called a plus-minus asymmetry decoding table. For example, the coding table illustrated in FIG. 5B is an example of the plus-minus asymmetry coding table. On the other hand, a coding method that provides the same code length for a positive value and a negative value if they have the same absolute value, as does the Exp-Golomb coding illustrated in FIG. 5A, is called a plus-minus symmetry coding method. Further, a coding table used for the plus-minus symmetry coding is called a plus-minus symmetry coding table, and a decoding table used for the plus-minus symmetry decoding is called a plus-minus symmetry decoding table.

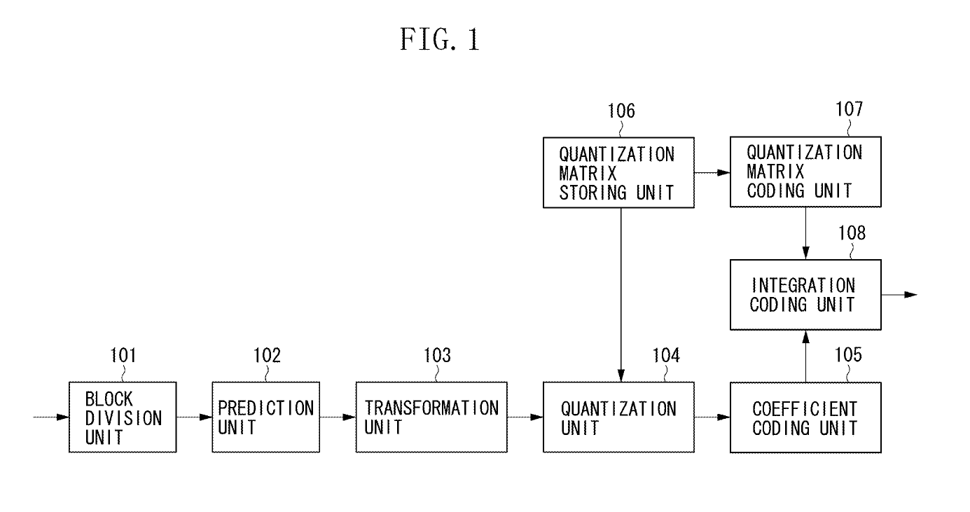

FIG. 1 is a block diagram illustrating an image coding apparatus according to a first exemplary embodiment of the present invention.

In FIG. 1, a block division unit 101 divides an input image into a plurality of blocks. A prediction unit 102 performs prediction of each block divided by the block division unit 101 in block units, determines a prediction method, calculates difference values according to the determined prediction method, and further calculates prediction errors. If an intra frame of a moving image or a still image is to be processed, intra prediction is performed. If an inter frame of a moving image is to be processed, motion compensated prediction is performed as well as the intra prediction. The intra prediction is generally realized by selecting a reference method, from a plurality of reference methods, for referencing reference pixels used for calculating the prediction value from data of neighboring pixels.

A transformation unit 103 performs orthogonal transform of the prediction errors of each block. The transformation unit 103 performs the orthogonal transform in units of blocks to calculate transform coefficients. The size of the block is the size of the input block or a size obtained by further segmenting the input block. In the following description, a block which is to be transformed by the orthogonal transform is called a transformation block. Although the method of the orthogonal transform is not limited, discrete cosine transform or Hadamard transform can be used. Further, according to the present embodiment, a prediction error in block units of 8×8 pixels is divided into two portions lengthwise and breadthwise and a resulting 4×4 pixel transformation block is used in the orthogonal transform to simplify the description. However, the size of the transformation block is not limited to such an example. For example, the orthogonal transform can be performed by using a transformation block of the same block size or a transformation block obtained by dividing the block into smaller portions than is obtained when the block is divided into two portions lengthwise and breadthwise.

A quantization matrix storing unit 106 generates and stores quantization matrices. The generation method of the quantization matrices which are stored in the quantization matrix storing unit is not limited. Thus, it can be quantization matrices input by the user, quantization matrices calculated from characteristics of an input image, or quantization matrices designated in advance as initial values.

A quantization unit 104 quantizes the transform coefficients by the quantization matrices stored in the quantization matrix storing unit 106. Quantization coefficients are obtained by this quantization process. A coefficient coding unit 105 codes the obtained quantization coefficients and generates quantization coefficient coded data. Although the coding method is not limited, coding such as Huffman coding and arithmetic coding can be used. A quantization matrix coding unit 107 codes the quantization matrices stored in the quantization matrix storing unit 106, and generates quantization matrix coded data.

An integration coding unit 108 generates header information as well as a code which are associated with the prediction or transformation, and also integrates the quantization coefficient coded data generated by the coefficient coding unit 105 and the quantization matrix coded data generated by the quantization matrix coding unit 107. The code associated with the prediction or transformation is, for example, a code associated with the selection of the prediction method or the division of the transformation block.

The coding operation of an image performed by the above-described image coding apparatus will now be described. According to the present embodiment, although moving image data is input to frame units, still image data of one frame can also be input. Further, according to the present embodiment, in order to simplify the description, only the processing of intra prediction coding is described. However, the present invention can also be applied to processing of inter prediction coding. According to the present embodiment, although the block division unit 101 divides an input image into blocks of 8×8 pixels, the size of the blocks is not limited to such an example.

When image data of one frame is input to the block division unit 101, it is divided into block units of 8×8 pixels. The divided image data is input to the prediction unit 102. The prediction unit 102 performs the prediction in block units and prediction errors are generated. The transformation unit 103 determines a transformation block size of the prediction errors generated by the prediction unit 102 and performs orthogonal transform to obtain transform coefficients. Then, the obtained transform coefficients are input to the quantization unit 104. According to the present embodiment, before the orthogonal transform is performed, prediction errors in block units of 8×8 pixels are divided into trans formation block units of 4×4 pixels.

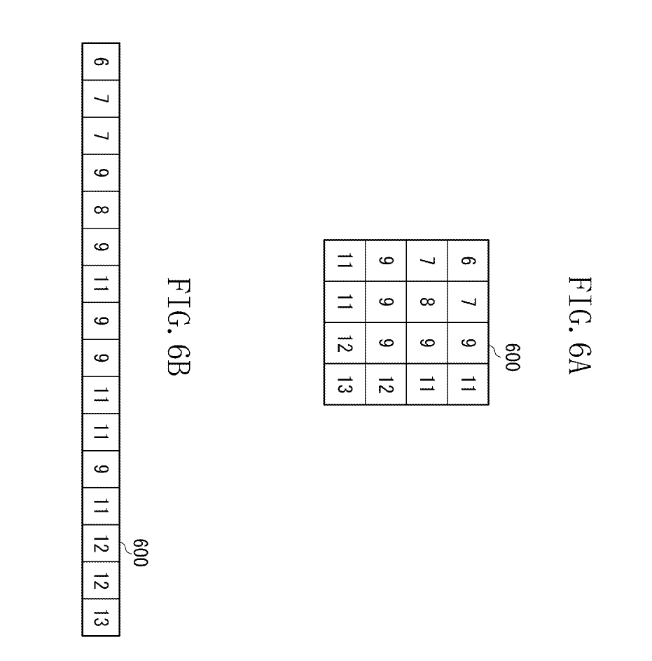

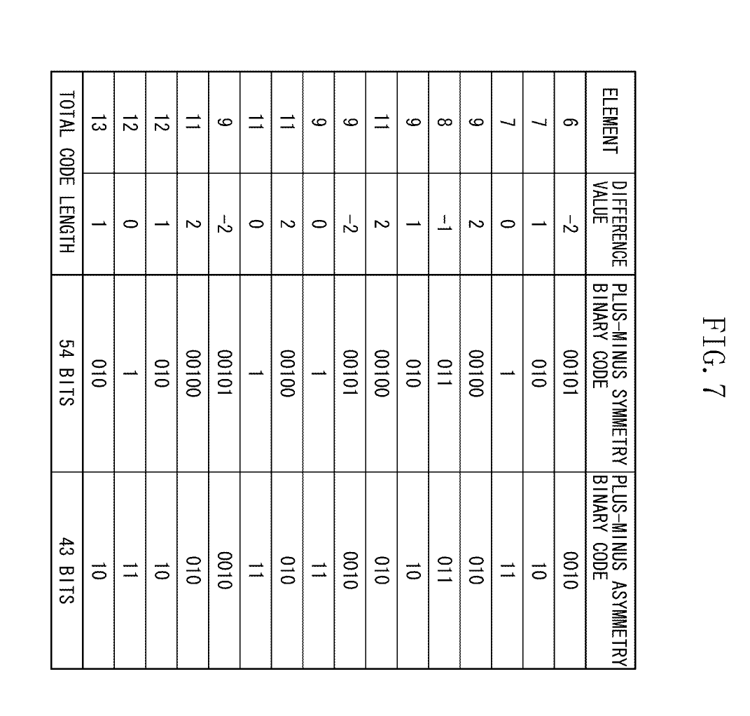

In the quantization matrix storing unit 106, there are quantization matrices stored and to be used for the quantization of the frame. FIGS. 6A and 6B illustrate an example of a quantization matrix corresponding to a transformation block of 4×4 pixels. The quantization matrix in FIG. 6A is a two-dimensional quantization matrix corresponding to transformation blocks of 4×4 pixels. FIG. 6B is a one-dimensional quantization matrix which is acquired by scanning of each element. The contents of the matrices are the same. According to the quantization matrices illustrated in FIGS. 6A and 6B of the present embodiment, although the quantization matrix illustrated in FIG. 6B is a one-dimensional matrix, the elements in the quantization matrix and the shape of the quantization matrix are not limited to such examples. For example, if a transformation block of 8×8 pixels is to be used in addition to the block size of the present embodiment, a different quantization matrix that corresponds to the transformation block of 8×8 pixels will be stored.

The quantization matrix coding unit 107 reads out the quantization matrices from the quantization matrix storing unit 106 in order, performs coding of the quantization matrices, and generates quantization matrix coded data. A concrete example of the coding method of the quantization matrix will now be described with reference to FIG. 6B. A thick frame 600 represents the quantization matrix. In order to simplify the description, the quantization matrix includes 16 pixels, which correspond to the transformation block of 4×4 pixels, and each cell in the thick frame represents an element. According to the present embodiment, the quantization matrix in FIG. 6B is coded. The generated quantization matrix coded data is output to the integration coding unit 108.

In FIG. 6B, the element of the quantization matrix starts with “6”. The value increases and decreases until it reaches “13”. For example, in coding the quantization matrix, the difference value, which is the difference between a predetermined initial value and “6” being the value of the first element, is coded. Regarding the subsequent element, the difference value, which is the difference between the element to be coded and its previous element, is coded in order. Regarding the coding of the first element, not the difference between the predetermined initial value and the element, but the value of the element itself (i.e., “6”) can be coded alternatively. According to the present embodiment, the difference value is coded using the plus-minus asymmetry coding table illustrated in FIG. 5B. However, the coding table is not limited to such an example. Any coding table can be used so long as it provides a shorter code length for a positive value than for a negative value in a case where the positive value and the negative value have the same absolute value.

FIG. 7 illustrates an example of a code obtained in a case where the predetermined initial value is set to “8” and the quantization matrices illustrated in FIGS. 6A and 6B are coded using the coding tables in FIGS. 5A and 5B. Each of the “element” columns in FIG. 7 presents each element of the quantization matrix in FIG. 6. Each of the “difference value” columns in FIG. 7 presents the difference value between an element and the predetermined initial value “8” or the previous element. Each of the “plus-minus symmetry binary code” columns present the code which is obtained when the plus-minus symmetry coding table illustrated in FIG. 5A is used, and a total of 54 bits is necessary. On the other hand, each of the “plus-minus asymmetry binary code” columns presents the code which is obtained when the plus-minus asymmetry coding table illustrated in FIG. 5B is used, and a total of 43 bits is necessary. According to the present embodiment, the same quantization matrix can be coded by a smaller amount of code.

Further, according to the present embodiment, although the quantization matrices are generated for each transformation block size, then coded. However, quantization matrices can be coded using quantization matrices corresponding to different transformation block sizes. For example, a quantization matrix of 8×8 pixels can be coded by each element. Further, for the coding of a quantization matrix of 4×4 pixels, a mean value of the quantization matrix of 8×8 pixels using 2×2 elements can be used as a prediction value. Then, the difference between the prediction value and each element of the quantization matrix of 4×4 pixels is coded.

Referring back again to FIG. 1, the quantization unit 104 quantizes the transform coefficients output from the transformation unit 103 by using the quantization matrices stored in the quantization matrix storing unit 106 and generates quantization coefficients. The generated quantization coefficients are input to the coefficient coding unit 105.

The coefficient coding unit 105 codes the quantization coefficients generated by the quantization unit 104, generates quantization coefficient coded data, and outputs the generated quantization coefficient coded data to the integration coding unit 108.

The integration coding unit 108 generates codes associated with a header of a sequence, a frame, a picture and a slice of an image. Further, the quantization matrix coded data generated by the quantization matrix coding unit 107 is inserted into one of these headers. A bit stream is generated by integration of the code in the header portion and the quantization coefficient coded data generated by the coefficient coding unit 105. Then, the bit stream is output.

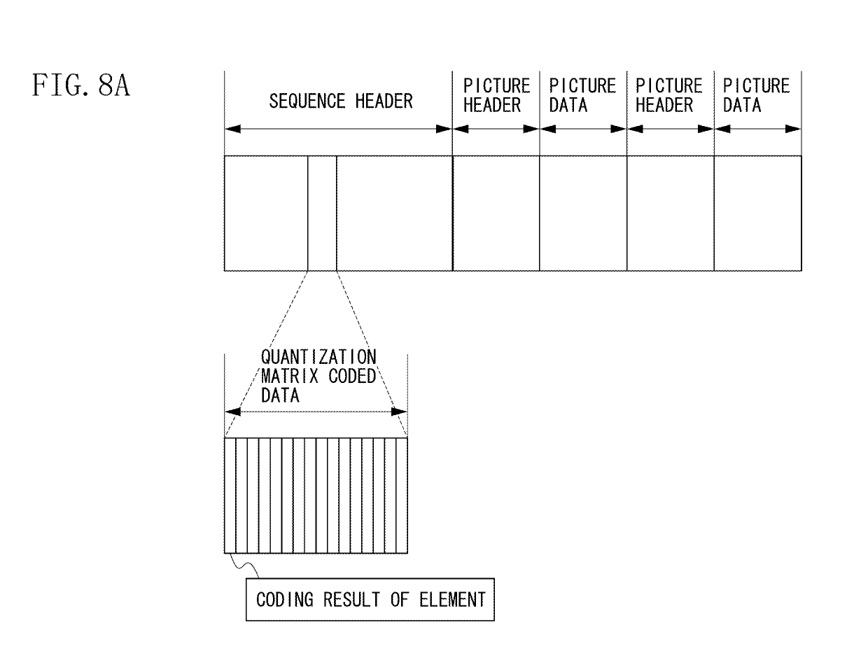

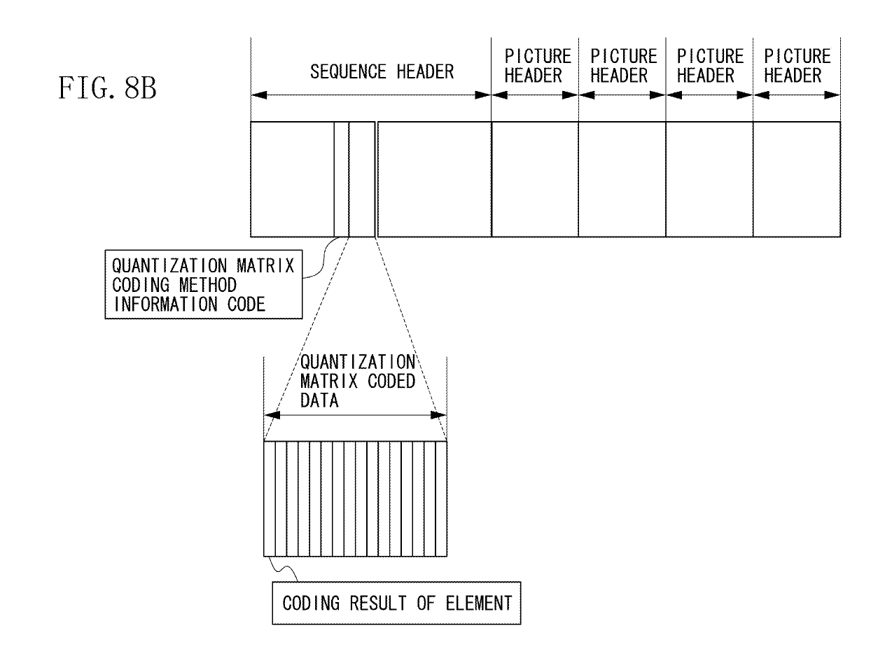

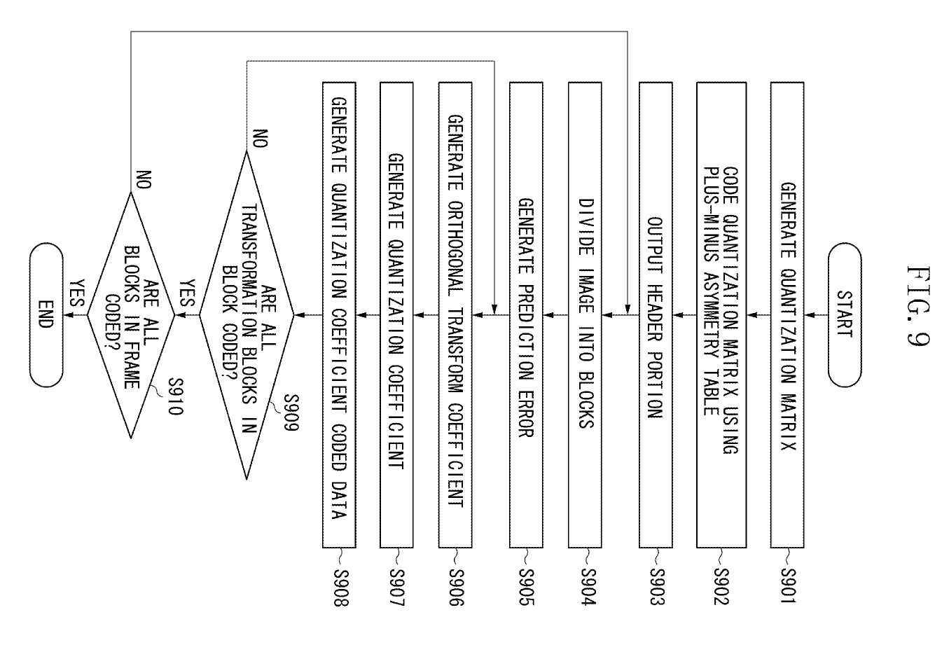

FIG. 8A illustrates an example of a bit stream that is output according to the first exemplary embodiment. According to the present embodiment, although the sequence header portion in a bit stream includes the coded quantization matrices, the position of the coded quantization matrix, however, is not limited to such a position. For example, the coded quantization matrix data can be included in the picture header portion or other header portions. Further, if the quantization matrix is to be changed in one sequence, the quantization matrix can be updated by newly coding the quantization matrix. In such a case, the entire quantization matrix can be rewritten. Further, if a scanning method and a transformation block size of the quantization matrix to be rewritten are designated, a portion of the quantization matrix can be changed according to the designation.

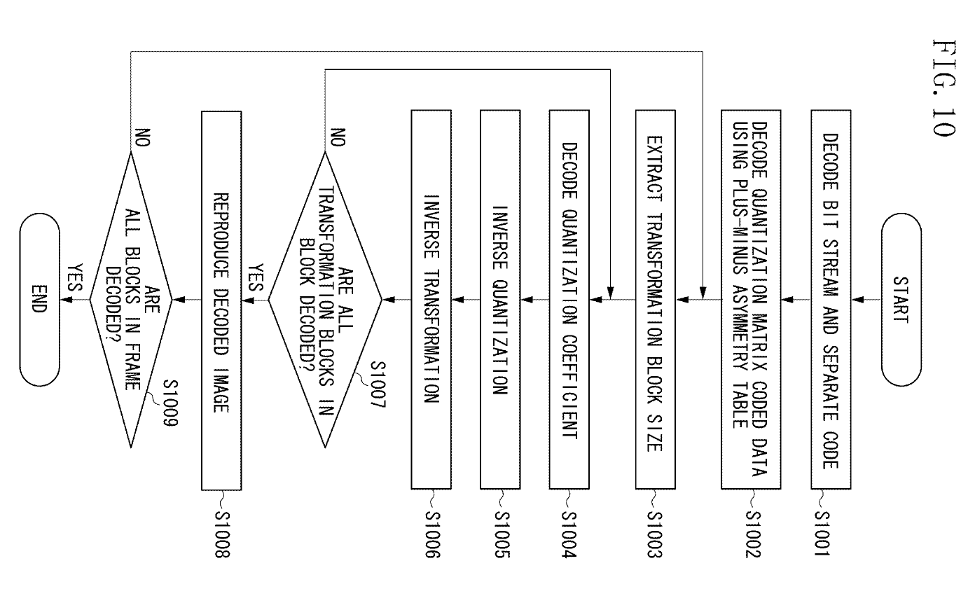

FIG. 9 is a flowchart illustrating the image coding processing performed by the image coding apparatus according to the first exemplary embodiment. In step S901, the quantization matrix storing unit 106 generates one or more quantization matrices.

In step S902, the quantization matrix coding unit 107 codes each quantization matrix generated by the quantization matrix storing unit 106. According to the present embodiment, the quantization matrix coding unit 107 codes the difference between each element of the quantization matrix and each previous element using the plus-minus asymmetry coding table illustrated in FIG. 5B. However, the coding table to be used is not limited to such an example. In step S903, the integration coding unit 108 performs coding of the header portion of the bit stream and outputs it.

In step S904, the block division unit 101 divides the input image in a unit of frame into a unit of block. In step S905, the prediction unit 102 performs the prediction in block units and generates prediction errors.

In step S906, the transformation unit 103 determines the transformation block size with respect to the prediction errors generated in step S905, performs orthogonal transform, and generates transform coefficients. In step S907, the quantization unit 104 performs quantization to the transform coefficients generated in step S906 using the quantization matrices stored in the quantization matrix storing unit 106 and generates quantization coefficients.

In step S908, the coefficient coding unit 105 codes the quantization coefficients generated in step S907 and generates quantization coefficient coded data.

In step S909, the image coding apparatus determines whether the coding of all the transformation blocks in the block is completed. If the coding of all the transformation blocks is completed (YES in step S909), the processing proceeds to step S910. If the coding of all the transformation blocks is not yet completed (NO in step S909), the processing returns to step S906, and the next transformation block is processed.

In step S910, the image coding apparatus determines whether the coding of all the blocks is completed. If the coding of all the blocks is completed (YES in step S910), all operations are stopped and the processing ends. If the coding of all the blocks is not yet completed (NO in step S910), the processing returns to step S904, and the next block is processed.

According to the above-described configuration and operation, especially by the coding processing using the plus-minus asymmetry coding table performed in step S902, a bit stream with a smaller amount of code of the quantization matrices can be generated.

According to the present embodiment, although a frame that uses only intra prediction is described, it is apparent that the present invention can also be applied to a frame that can use inter prediction. Further, according to the present embodiment, although a block of 8×8 pixels and a transformation block of 4×4 pixels are used, the present invention is not limited to such examples. For example, the block size can be 16×16 pixels or 32×32 pixels. Further, the shape of the block is not limited to a square and, for example, a rectangle of 16×8 pixels can be used.

Further, although the transformation block size is half of the block size lengthwise and breadthwise in the present embodiment, the transformation block size can be the same as the block size or further smaller than half the size of the block lengthwise and breadthwise.

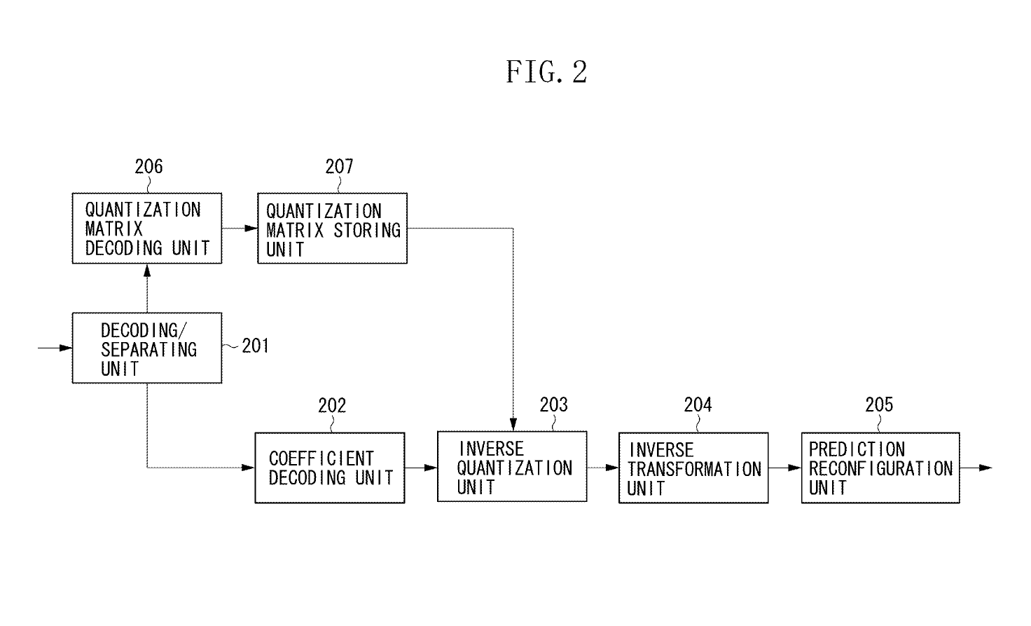

FIG. 2 is a block diagram illustrating a configuration of an image decoding apparatus according to a second exemplary embodiment of the present invention. According to the present embodiment, decoding of the bit stream generated in the first exemplary embodiment will be described.

In FIG. 2, a decoding/separating unit 201 decodes the header information of the input bit stream, separates necessary codes from the bit stream, and outputs the separated codes to the subsequent stages. The decoding/separating unit 201 performs an inverse operation of the operation performed by the integration coding unit 108 illustrated in FIG. 1.

A quantization matrix decoding unit 206 decodes the quantization matrix coded data from the header information of the bit stream. A quantization matrix storing unit 207 temporarily stores the quantization matrices decoded by the quantization matrix decoding unit 206.

On the other hand, a coefficient decoding unit 202 decodes information of the transformation block size from the code separated by the decoding/separating unit 201, further decodes the quantization coefficient code for each decoded transformation block size, and reproduces the quantization coefficients.

An inverse quantization unit 203 performs inverse quantization to the quantization coefficients by using the quantization matrices stored in the quantization matrix storing unit 207, and reproduces transform coefficients. An inverse transformation unit 204 performs inverse orthogonal transform, which is an inverse operation of the operation performed by the transformation unit 103 illustrated in FIG. 1, and reproduces prediction errors. A prediction reconfiguration unit 205 reproduces block image data from the prediction errors and neighboring image data already decoded.

The decoding operation of an image according to the above-described image decoding apparatus will now be described. According to the present embodiment, although a bit stream of a moving image generated in the first exemplary embodiment is input in the unit of frame, a bit stream of a still image of one frame can also be input. Further, according to the present embodiment, in order to simplify the description, only intra prediction decoding process is described. However, the present invention can also be applied to inter prediction decoding process.

Regarding the illustration in FIG. 2, a bit stream of one frame is input to the decoding/separating unit 201, and header information necessary in reproducing the image is decoded. Further, codes used in the subsequent stages are separated from the header information and output. The quantization matrix coded data included in the header information is input to the quantization matrix decoding unit 206 and quantization matrices used in the inverse quantization processing in the subsequent stage is reproduced. According to the present embodiment, by using the plus-minus asymmetry decoding table illustrated in FIG. 5B, a difference value of each element of the quantization matrices is decoded and the quantization matrices are reproduced using the difference value and the predetermined initial value. However, the decoding table is not limited to the table illustrated in FIG. 5B. The reproduced quantization matrices are temporary stored in the quantization matrix storing unit 207.

Further, out of the codes separated by the decoding/separating unit 201, the information of the transformation block size and quantization coefficient coded data is input to the coefficient decoding unit 202. Then, the coefficient decoding unit 202 extracts the transformation block size from the information of the transformation block size that has been input. Further, based on the extracted transformation block size, the coefficient decoding unit 202 decodes the quantization coefficient coded data for each transformation block, reproduces the quantization coefficients, and outputs the reproduced quantization coefficients to the inverse quantization unit 203.

In addition to the quantization coefficients reproduced by the coefficient decoding unit 202, the quantization matrices stored in the quantization matrix storing unit 207 are input to the inverse quantization unit 203. Then, the inverse quantization unit 203 performs inverse quantization by using the quantization matrices, reproduces the transform coefficients, and outputs the reproduced transform coefficients to the inverse transformation unit 204. The inverse transformation unit 204 performs the inverse orthogonal transform, which is an inverse operation of the operation performed by the transformation unit 103 illustrated in FIG. 1, to the input orthogonal transform coefficients, reproduces the prediction errors, and outputs the prediction errors to the prediction reconfiguration unit 205

The prediction reconfiguration unit 205 performs the prediction based on the input prediction errors and using the data of the neighboring decoding-finished pixels, reproduces the image data in block units, and outputs the image data.

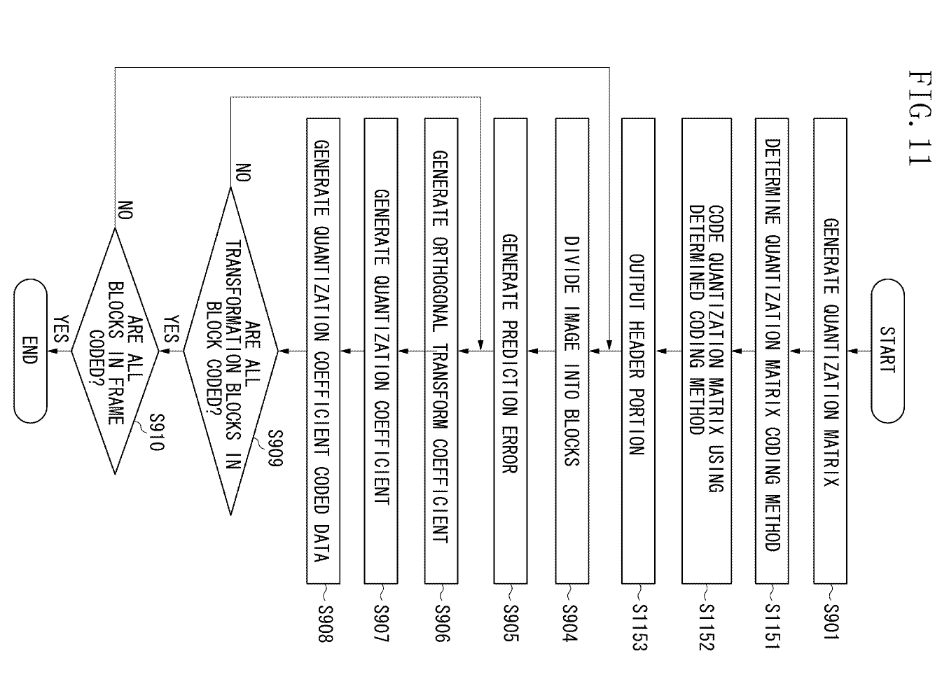

FIG. 10 is a flowchart illustrating the image decoding processing of the image decoding apparatus according to the second exemplary embodiment. In step S1001, the decoding/separating unit 201 decodes the header information and separates the codes to be output to the subsequent stages.

In step S1002, the quantization matrix decoding unit 206 decodes the quantization matrix coded data included in the header information using the plus-minus asymmetry table illustrated in FIG. 5B and reproduces the quantization matrices used by the inverse quantization processing in the subsequent stage.

In step S1003, the coefficient decoding unit 202 decodes the information regarding the size of each transformation block of the block to be decoded, and extracts the transformation block size. In step S1004, the coefficient decoding unit 202 decodes the quantization coefficient coded data in units of transformation blocks and reproduces the quantization coefficients.

In step S1005, the inverse quantization unit 203 performs inverse quantization of the quantization coefficients reproduced in step S1004 by using the quantization matrices decoded in step S1002, and reproduces transform coefficients. In step S1006, the inverse transformation unit 204 performs the inverse orthogonal transformation to the transform coefficients reproduced in step S1005, and reproduces the prediction errors.

In step S1007, the image decoding apparatus determines whether the decoding of all the transformation blocks in the block is completed. If the decoding of all the transformation blocks is completed (YES in step S1007), the processing proceeds to step S1008. If the decoding of all the transformation blocks is not yet completed (NO in step S1007), the processing returns to step S1004, and the next transformation block is processed.

In step S1008, the prediction reconfiguration unit 205 performs the prediction using the neighboring pixels already decoded, adds the result to the prediction errors reproduced in step S1006, and reproduces the decoded image of the block.

In step S1009, the image decoding apparatus determines whether the decoding of all the blocks is completed. If the decoding of all the blocks is completed (YES in step S1009), all the operations are stopped and the processing ends. If the decoding of all the blocks is not yet completed (NO in step S1009), the processing returns to step S1003, and the next block is processed.

According to the above-described processing, decoding of the bit stream having a smaller amount of code of the quantization matrix generated according to the first exemplary embodiment is performed, and the reproduced image can be obtained. Further, as is described in the first exemplary embodiment, the size of the block, the size of the transformation block, and the shape of the block are not limited to the above-described examples.

Further, according to the present embodiment, by using the plus-minus asymmetry decoding table illustrated in FIG. 5B, the difference value of each element of the quantization matrices is decoded, and the quantization matrices are reproduced from the difference value and the predetermined initial value. However, the decoding table is not limited to such a table.

Further, if one sequence of a bit stream contains several quantization matrix coded data, the quantization matrices can be updated. In such a case, the decoding/separating unit 201 detects the quantization matrix coded data and decodes the quantization matrix coded data by the quantization matrix decoding unit 206. The decoded data of the quantization matrix replaces the corresponding quantization matrices stored in the quantization matrix storing unit 207. In such a case, the entire quantization matrix can be rewritten. Alternatively, a portion of the quantization matrix can be rewritten by determining the portion to be rewritten.

According to the present embodiment, although the processing is performed after the coded data of one frame is accumulated, the present invention is not limited to such an example. For example, the data can be input in a unit of block or in a unit of slice. A slice includes a plurality of blocks. Further, in place of blocks, data divided into packets of a fixed length can be input.

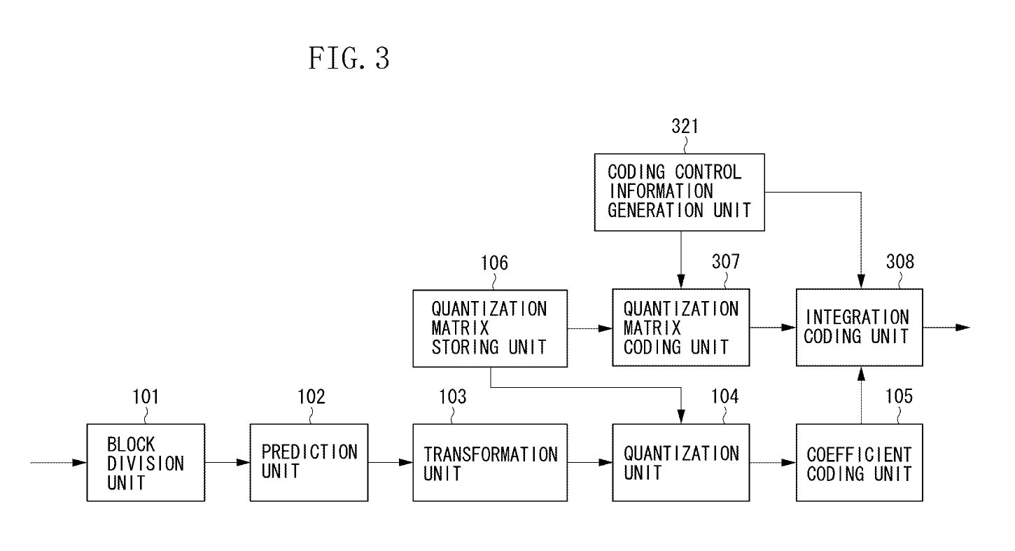

FIG. 3 is a block diagram illustrating the image coding apparatus according to a third exemplary embodiment of the present invention. In FIG. 3, components similar to those in FIG. 1 of the first exemplary embodiment are denoted by the same reference numerals and their descriptions are not repeated.

A coding control information generation unit 321 generates quantization matrix coding method information, which is information of a coding method of each quantization matrix. A quantization matrix coding unit 307 codes the quantization matrices stored in the quantization matrix storing unit 106 and generates the quantization matrix coded data using the quantization matrix coding method information generated by the coding control information generation unit 321.

An integration coding unit 308 generates header information and codes associated with the prediction and the transformation as is performed by the integration coding unit 108 in FIG. 1. The integration coding unit 308 is different from the integration coding unit 108 such that it inputs the quantization matrix coding method information generated by the coding control information generation unit 321 and codes it.

The image coding operation performed by the above-described image coding apparatus will now be described. The coding control information generation unit 321 generates quantization matrix coding method information, which is information indicating how each quantization matrix is coded. According to the present embodiment, if the quantization matrix coding method information is “0”, the difference value of each element and each previous element of the quantization matrices is coded using the coding table of the plus-minus symmetry illustrated in FIG. 5A. Further, if the quantization matrix coding method information is “1”, the difference value of each element and each previous element of the quantization matrices are coded using the coding table of the plus-minus asymmetry illustrated in FIG. 5B. The coding method of each element of the quantization matrices is not limited to the above-described examples and coding tables other than those illustrated in FIGS. 5A and 5B can also be used.

Further, the combination of the quantization matrix coding method information and the coding method of the quantization matrix is not limited to the above-described example. The generation method of the quantization matrix coding method information is not limited. Thus, the information can be a value input by the user, a value designated as a fixed value, or a value calculated from the characteristics of the quantization matrices stored in the quantization matrix storing unit 106. The generated quantization matrix coding method information is input to the quantization matrix coding unit 309 and the integration coding unit 308.

Based on the quantization matrix coding method information that has been input, the quantization matrix coding unit 307 codes each quantization matrix stored in the quantization matrix storing unit 106, generates quantization matrix coded data, and outputs it to the integration coding unit 308

The integration coding unit 308 codes the quantization matrix coding method information generated by the coding control information generation unit 321, generates a quantization matrix coding method information code, and outputs the generated quantization matrix coding method information code by incorporating it in the header information. Although the coding method is not limited, Huffman coding and arithmetic coding can be used. FIG. 8B illustrates an example of a bit stream including the quantization matrix coding method information code. The quantization matrix coding method information code can be included in either the sequence header or the picture header. However, the quantization matrix coding method information code needs to exist before each piece of quantization matrix coded data.

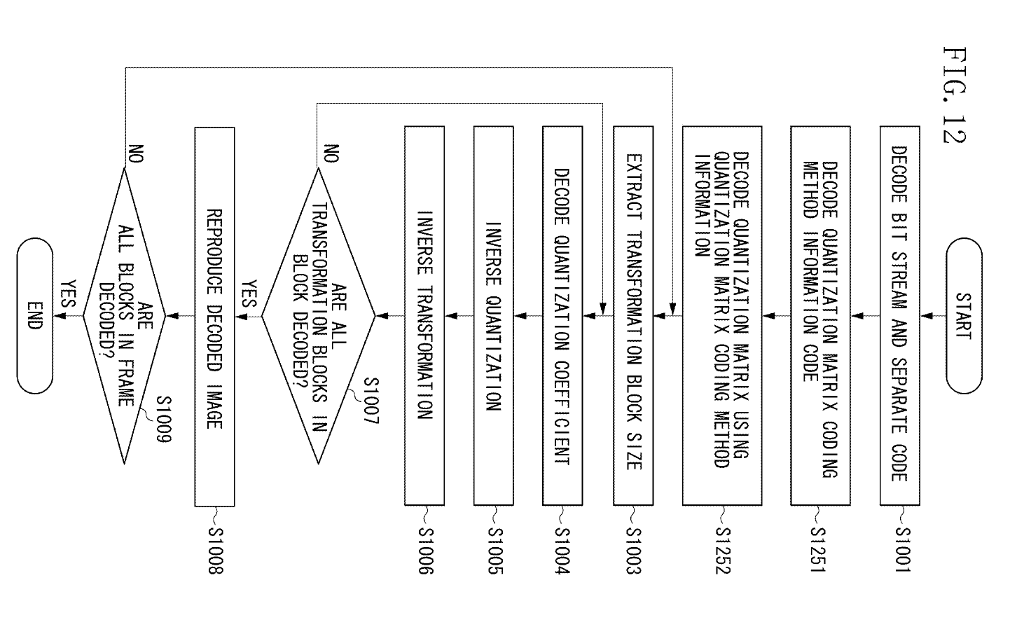

FIG. 11 is a flowchart illustrating the image coding processing of the image coding apparatus according to the third exemplary embodiment. In FIG. 11, components similar to those in FIG. 9 of the first exemplary embodiment are denoted by the same reference numerals and their descriptions are not repeated.

In step S1151, the coding control information generation unit 321 determines the quantization matrix coding method to be used in step S1152. In step S1152, based on the quantization matrix coding method determined in step S1151, the quantization matrix coding unit 307 codes the quantization matrices generated in step S901.

In step S1153, the quantization matrix coding unit 307 codes the quantization matrix coding method information, generates a quantization matrix coding method information code, and incorporates it in the header portion as other codes are incorporated, and outputs the header portion.

According to the above-described configuration and operation, each quantization matrix is coded by an optimum coding method, and a bit stream with a smaller amount of code of the quantization matrices can be generated.

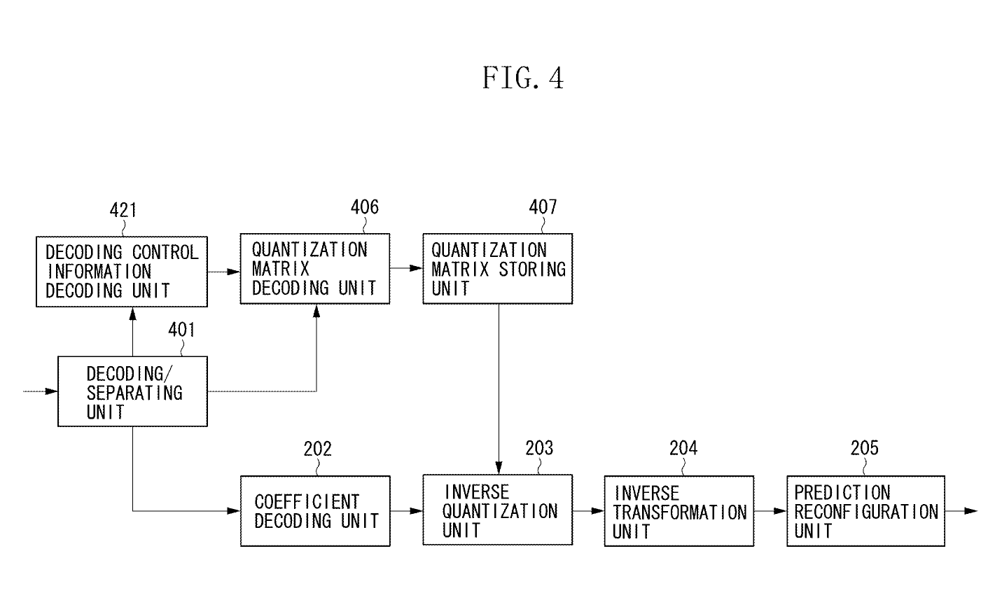

FIG. 4 is a block diagram illustrating the image decoding apparatus according to a fourth exemplary embodiment of the present invention. In FIG. 4, components similar to those in FIG. 2 of the second exemplary embodiment are denoted by the same reference numerals and their descriptions are not repeated. According to the present embodiment, decoding of the bit stream generated in the third exemplary embodiment will be described.

A decoding/separating unit 401 decodes header information of the bit stream which has been input, separates the necessary codes from the bit stream, and outputs the codes to the subsequent stages. The decoding/separating unit 401 is different from the decoding/separating unit 201 illustrated in FIG. 2 in that the quantization matrix coding method information code is separated from the header information of the bit stream and that it is output to the subsequent stage.

A decoding control information decoding unit 421 decodes the quantization matrix coding method information code separated by the decoding/separating unit 401, and reproduces the information of the quantization matrix coding method. A quantization matrix decoding unit 406 decodes the quantization matrix coded data separated from the header information of the bit stream by the decoding/separating unit 401 based on the quantization matrix coding method information.

The image decoding operation of the above-described image decoding apparatus will now be described.

In FIG. 4, a input bit stream of one frame is input to the decoding/separating unit 401 and header information necessary in reproducing the image is decoded. Further, the codes used in the subsequent stages are separated and output. The quantization matrix coding method information code included in the header information is input to the decoding control information decoding unit 421, and the quantization matrix coding method information is reproduced. Then, the reproduced quantization matrix coding method information is input to the quantization matrix decoding unit 406.

On the other hand, the quantization matrix coded data in the header information is input to the quantization matrix decoding unit 406. Then, based on the input information of the coding method of the quantization matrix, the quantization matrix decoding unit 406 decodes the quantization matrix coded data, and reproduces the quantization matrices used for the inverse quantization processing in the subsequent stage. The reproduced quantization matrices are stored in the quantization matrix storing unit 207.

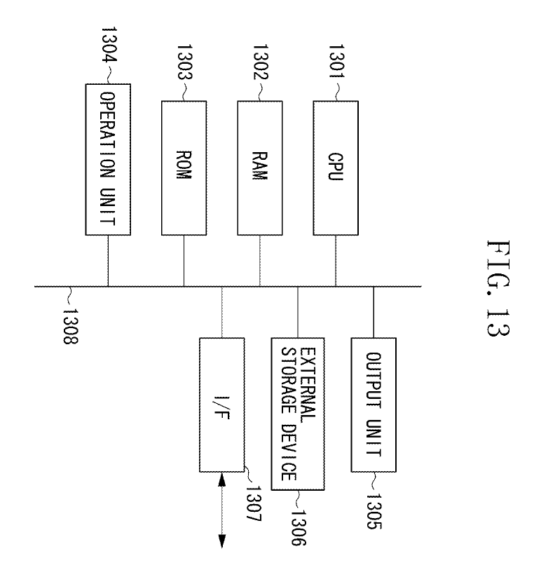

FIG. 12 is a flowchart illustrating the image decoding processing of the image decoding apparatus according to the fourth exemplary embodiment. In FIG. 12, components similar to those in FIG. 10 of the second exemplary embodiment are denoted by the same reference numerals and their descriptions are not repeated.

In step S1001, the decoding/separating unit 401 decodes the header information.

In step S1251, the decoding control information decoding unit 421 decodes the quantization matrix coding method information code included in the header information, and reproduces the quantization matrix coding method information.

In step S1252, the quantization matrix decoding unit 406 decodes the quantization matrix coded data included in the header information based on the quantization matrix coding method information reproduced in step S1251, and reproduces the quantization matrices.

According to the above-described configuration and operation, each quantization matrix generated according to the third exemplary embodiment is coded by an optimum coding method, and a bit stream of a smaller amount of code of the quantization matrices is decoded, and a reproduced image can be obtained.

According to a fifth exemplary embodiment of the present invention, the configuration of the image coding apparatus is similar to the image coding apparatus of the first exemplary embodiment illustrated in FIG. 1. However, the operation of the quantization matrix coding unit 107 is different. Since, processing other than the processing of the quantization matrix coding unit 107 is similar to that of the first exemplary embodiment, the description of such processing is not repeated.

Although the quantization matrix coding unit 107 reads the quantization matrices in order from the quantization matrix storing unit 106, codes them, and generates quantization matrix coded data, the coding method is different from the method of the quantization matrix coding unit 107 described according to the first exemplary embodiment.

The coding method of the quantization matrix according to the present embodiment will be described with reference to FIG. 6B. In FIG. 6B, the element of a quantization matrix starts with “6”. The value increases and decreases until it reaches “13”. In coding this quantization matrix, a difference value between the predetermined initial value and “6” as the value of the first element is coded. Then, the difference value between the element to be coded and the previous element is coded. Further, regarding the coding of the first element, the value of the element itself (i.e., “6”) can be coded in place of a difference between an element and a predetermined initial value.

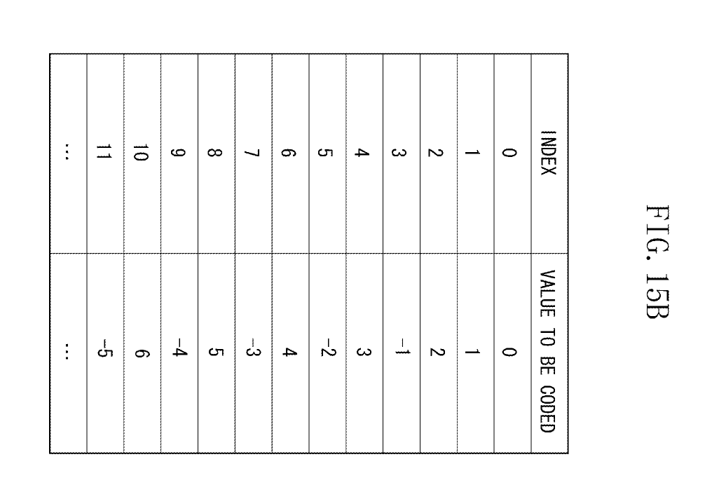

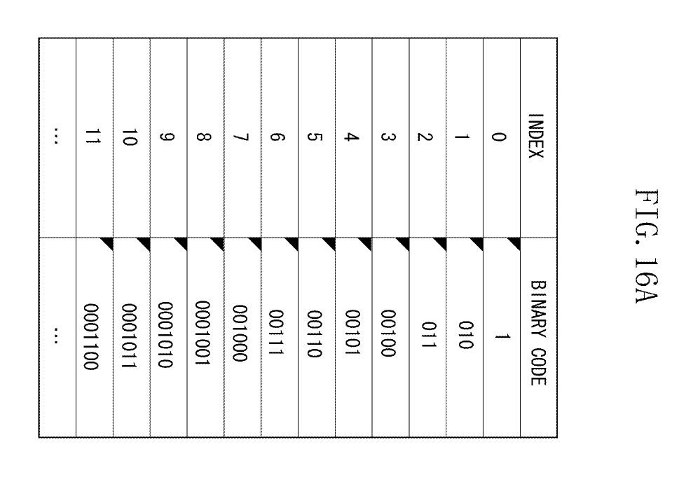

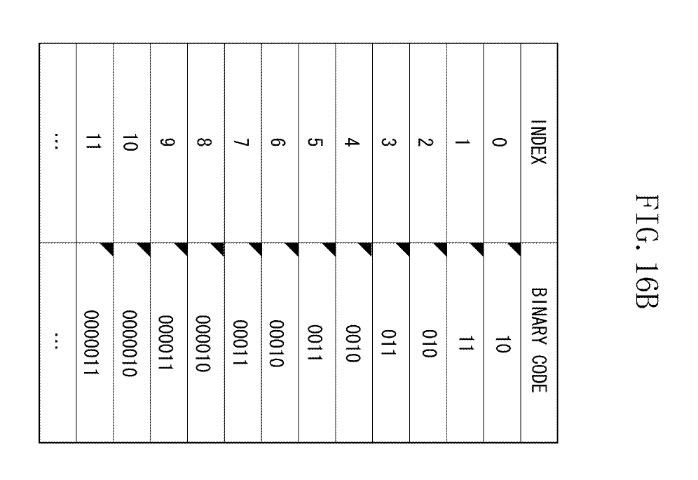

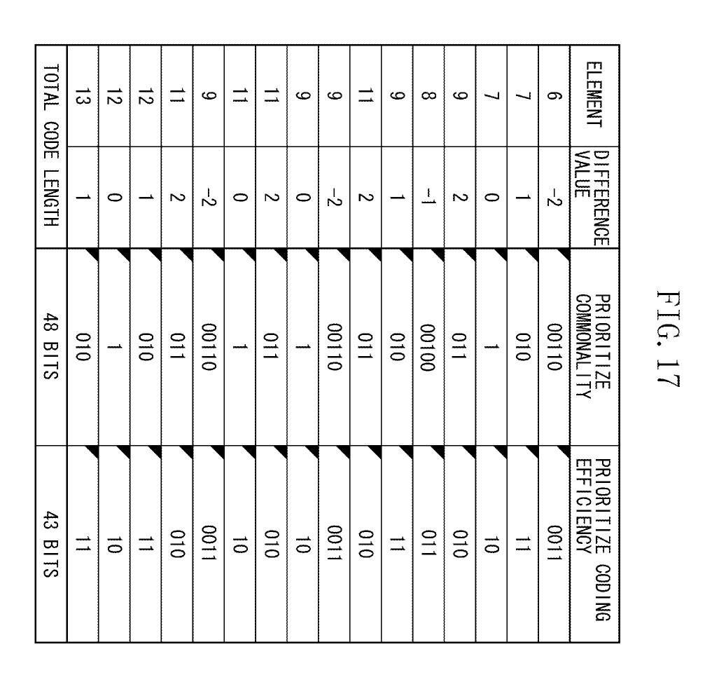

According to the present embodiment, the coding of the difference value is performed by mapping the difference value to an index having a positive value using the table illustrated in FIG. 15B so that a binary code corresponding to the code in the coding table illustrated in FIG. 16A is generated. However, the table is not limited to such an example.

The table used for mapping a difference value to an index of a positive value needs only to satisfy the following two conditions. The first condition is that if there are a positive value and a negative value having the same absolute value, the index corresponding to the negative value is always greater than the index corresponding to the positive value. The second condition is that if an index having a smaller value than an index corresponding to a negative value exists, at least one positive value greater than the absolute value of the negative value exists. The above-described conditions will be described using concrete examples. FIG. 15A illustrates a table used for mapping a value to be coded to a positive index, and is also used for H.264. Although this table satisfies the first condition, it does not satisfy the second condition. On the other hand, FIG. 15B illustrates a table used in the present embodiment. The index corresponding to a value to be coded “−1” is “3” and the index corresponding to a value to be coded “2” is “2”. Thus, the table satisfies the above-described two conditions. The table in FIG. 16B is based on the table in FIG. 15A. However, the value of the index corresponding to the first negative value in the order of the indices in the table (i.e., “−1”) is increased by “1” compared to the table in FIG. 16A. By using a similar method, a table used for mapping a difference value to an index of a positive value can be generated from an existing table. However, such a table can be generated by an entirely different method. If the above-described two conditions are satisfied, the generation method of the table is not limited.

According to the present embodiment, commonality of the coding table is prioritized. Thus, the coding table illustrated in FIG. 16A is used as is used in H.264. However, coding efficiency can also be prioritized, and a different coding table, such as the one illustrated in FIG. 16B, can also be used alternatively.

FIG. 17 illustrates examples of the codes obtained in a case where the quantization matrix illustrated in FIG. 6B having the predetermined initial value set to “8” is coded using the tables illustrated in FIGS. 15B and 16A and prioritizing the commonality as well as using the tables illustrated in FIGS. 15B and 16B and prioritizing the coding efficiency. Each of the “element” columns in FIG. 17 presents each element of the quantization matrix in FIG. 6B. Each of the “difference value” columns in FIG. 17 presents the difference value between an element and the predetermined initial value “8” or the previous element. Each of the “prioritize commonality” columns presents the code which is obtained when the tables in FIGS. 15B and 16A are used, and a total of 48 bits is necessary. On the other hand, each of the “prioritize coding efficiency” columns presents the code which is obtained when the tables in FIGS. 15B and 16B are used, and a total of 43 bits is necessary. According to the present embodiment, in either case, the same quantization matrix can be coded by a smaller amount of code compared to a case where the conventional method using the plus-minus symmetry coding table illustrated in FIG. 5A that requires a total of 54 bits is used.

The flowchart of the image coding process according to the present embodiment is similar to the flowchart according to the first exemplary embodiment illustrated in FIG. 9 except for the operation in step S902. Since operations other than what is performed in step S902 are similar to those described in the first exemplary embodiment, their descriptions are not repeated.

In step S902, the quantization matrix coding unit 107 codes each quantization matrix generated by the quantization matrix storing unit 106. According to the present embodiment, a case where the quantization matrix illustrated in FIG. 6B is generated in step S901 will be taken as an example. The quantization matrix coding unit 107 performs mapping of the difference between each element and the previous element of the generated quantization matrix with respect to an index having a positive value using the table illustrated in FIG. 15B, and performs coding using the coding table illustrated in FIG. 16A. The table used for mapping the difference to a positive value and the table used for coding the index are not limited to the above described examples.

According to the above-described configuration and operation, by using the existing coding table, a bit stream with a smaller amount of code of the quantization matrices can be generated while preventing the circuit size from increasing.

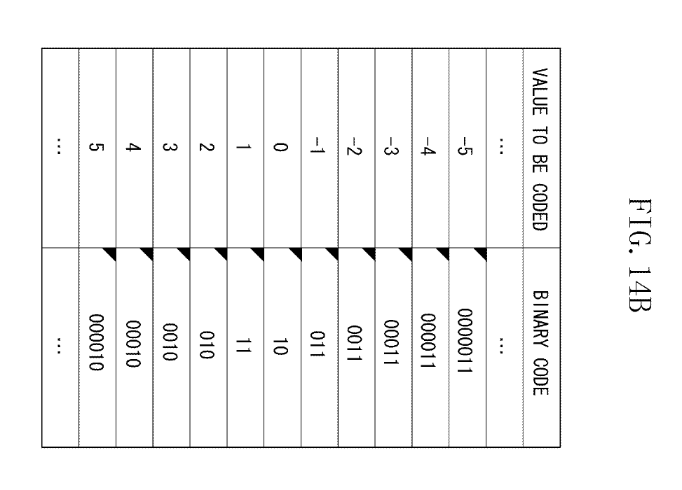

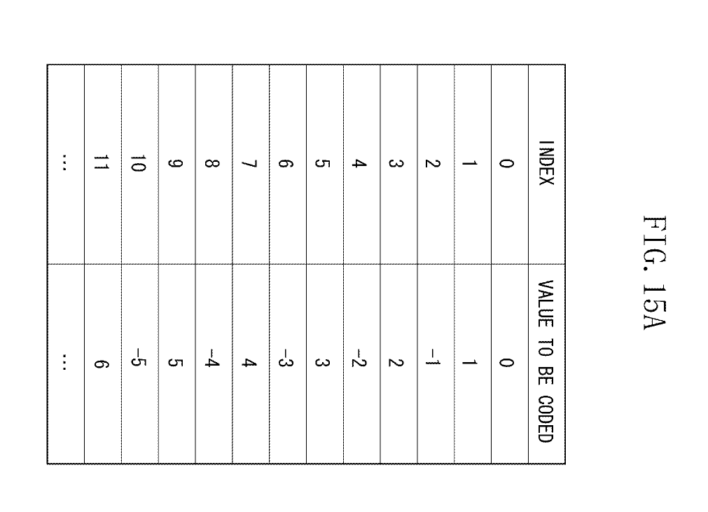

According to the present embodiment, coding the difference values calculated from the quantization matrices requires two stages. In other words, the difference values are temporarily transformed into indices having a positive value, then they are coded. However, by providing an appropriate coding table, the difference values can be coded in a single stage. For example, the processing used in coding the difference values illustrated in the present embodiment by transforming it into indices using the table in FIG. 16B and coding the index using the table in FIG. 16A is similar to the processing of direct coding of the difference value using the table in FIG. 14A. On the other hand, for example, the processing of direct coding using the table in FIG. 14B can be set in two stages such as transforming a difference value into an index using the table in FIG. 15B and coding it using the table in FIG. 16B. Further, if the index transformation using the table illustrated in FIG. 15A and the coding processing using the table in FIG. 16A are combined, since it is similar to the coding processing using the table illustrated in FIG. 5A, a coding table can be generated according to a combination of such processing. The coding table can also be generated by adjusting codes in an existing coding table using assumed probability distribution. For example, considering the probability distribution of the values to be coded, the coding table in FIG. 5B can be generated based on the coding table in FIG. 5A and changing the binary codes that correspond to the values “−2”, “0”, “1”, and “2”. Further, in FIG. 15B, if the incidence of positive values is still higher, the codes in the table can be adjusted by increasing the value of the index corresponding to the first negative value in the order of indices in the table. Information of the adjustment can be coded and included in the header. For example, if the table in FIG. 15B is generated from the table in FIG. 15A, since the index corresponding to the value to be coded “−1” is increased by “1”, “1” is coded and included in the header. In this manner, an optimum table can be used in the coding of each quantization matrix.

Further, by including the coded information used for changing tables in the header, coding that prioritizes commonality can be changed to coding that prioritizes coding efficiency and vice versa. Thus, the table can be changed according to the application. Further, by including information useful in changing tables according to the incidence of occurrence of the positive values in the header, optimum coding according to the incidence of occurrence can be performed.

According to a sixth exemplary embodiment of the present invention, the image decoding apparatus has a configuration similar to the image decoding apparatus of the second exemplary embodiment illustrated in FIG. 2. However, the operation of the quantization matrix decoding unit 206 is different. Since, the processing of the present embodiment is similar to that of the second exemplary embodiment except for the operation performed by the quantization matrix decoding unit 206, the description of similar processing is not repeated. According to the present embodiment, decoding of the bit stream generated according to the fifth exemplary embodiment will be described.

The quantization matrix decoding unit 206 performs a reverse operation of the quantization matrix coding unit 107 according to the fifth exemplary embodiment. The quantization matrix coded data included in the header information is input to the quantization matrix decoding unit 206 and the quantization matrices used in the inverse quantization processing in the subsequent stage are reproduced. According to the present embodiment, an index having a positive value is reproduced by using the decoding table illustrated in FIG. 16A, a difference value of each element of quantization matrices is generated by using the table in FIG. 16B, and quantization matrices are reproduced from the difference value and the predetermined initial value. However, the tables to be used are not limited to the above-described examples. Different tables can be used so long as it corresponds to the tables used in the sixth exemplary embodiment.

The flowchart of the image decoding processing according to the present embodiment is similar to the flowchart of the second exemplary embodiment illustrated in FIG. 10 except for the operation in step S1002. Thus, operations other than step S1002 are similar to those of the second exemplary embodiment and their descriptions are not repeated.

In step S1002, the quantization matrix decoding unit 206 decodes the quantization matrix coded data included in the header information by using the tables in FIGS. 16A and 16B, reproduces the difference values, and generates the quantization matrices used in the inverse quantization processing in the subsequent stage. According to the present embodiment, the quantization matrix coded data of 48 bits in the columns of “prioritize commonality” in FIG. 17 will be described. The quantization matrix coded data is decoded using the decoding table illustrated in FIG. 16A and indices having a positive value are reproduced. Next, according to the table illustrated in FIG. 15B, a matrix of difference values, which are the difference values in the columns of “difference value” in FIG. 17, is generated. Then, by adding the first difference value to the initial value being “8” and further adding a subsequent difference value to the previous element, each element of the quantization matrix in the columns of “element” in FIG. 17 is reproduced. Accordingly, the quantization matrix is generated. Similarly, the quantization matrix coded data of 43 bits presented in the columns of “prioritize coding efficiency” illustrated in FIG. 17 can also be decoded using the decoding table in FIG. 16B and the table in FIG. 15B.

According to the above-described configuration and operation, by commonly using the existing decoding table, a bit stream with a smaller amount of code of the quantization matrices generated according to the fifth exemplary embodiment can be decoded and the image can be reproduced while preventing the circuit size from increasing.

According to the present embodiment, calculating the difference values from the quantization matrix coded data requires two stages. In other words, indices having positive values are generated by decoding quantization matrix coded data, and then the difference values are calculated. However, by providing an appropriate decoding table, the difference values can be obtained in a single stage. For example, the processing that reproduces an index from the quantization matrix coded data according to the present embodiment using the table illustrated in FIG. 16A and transforming it to a difference value by using the table illustrated in FIG. 15B is similar to the processing of direct decoding using the table illustrated in FIG. 14A. On the other hand, for example, the processing of direct decoding using the table in FIG. 14B can be set in two stages such as decoding the quantization matrix coded data using the table in FIG. 16B and transforming it using the table in FIG. 15B. Further, if the decoding processing using the table illustrated in FIG. 16A and the index transformation using the table in FIG. 15A are combined, since it is similar to the decoding processing using the table illustrated in FIG. 5A, a decoding table can be generated according to a combination of such processing.

Further, by extracting information used for changing tables from the header and decoding it, it can be determined whether the commonality or the coding efficiency has been prioritized in the coding processing. Thus, optimum decoding can be performed.

According to the above-described exemplary embodiment, each processing unit illustrated in FIGS. 1 to 4 is realized by a hardware component. However, the processing performed by each processing unit illustrated in FIGS. 1 to 4 can be performed by a computer-executable program.

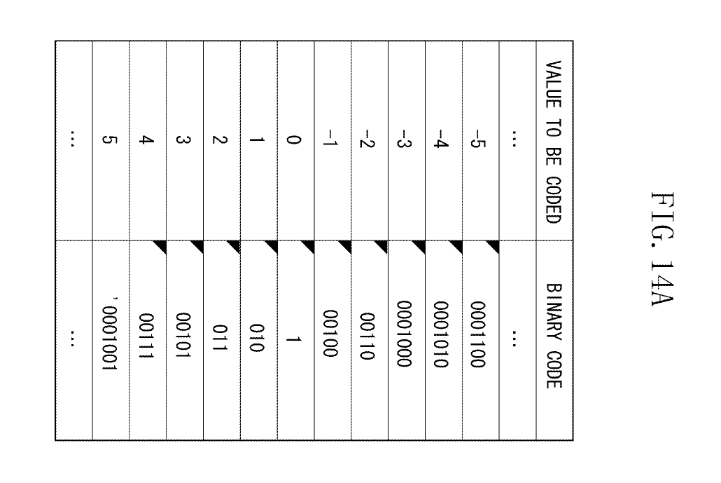

FIG. 13 is a block diagram illustrating an example of a hardware configuration of a computer which can be used for the image processing apparatus according to the above-described exemplary embodiments.

A central processing unit (CPU) 1301 controls the entire computer according to a computer program or data stored in a random access memory (RAM) 1302 or a read-only memory (ROM) 1303. Further, the CPU 1301 executes the above-described processing performed by the image processing apparatus according to the above-described exemplary embodiments. In other words, the CPU 1301 functions as each of the processing units illustrated in FIGS. 1 to 4.

The RAM 1302 includes an area used for temporarily storing a computer program or data loaded from an external storage device 1306 or data acquired externally via an interface (I/F) 1309. Further, the RAM 1302 includes a work area which is used when the CPU 1301 executes various types of processing. In other words, the RAM 1302 can be assigned as a frame memory or arbitrarily provide other various areas.

Setting data of the computer and programs such as a boot program are stored in the ROM 1303. An operation unit 1304 includes a keyboard or a mouse. By the user of the computer operating the operation unit 1304, various instructions are input to the CPU 1301. An output unit 1305 displays the result of the processing executed by the CPU 1301. The output unit 1305 is, for example, a display device such as a liquid crystal display.

The external storage device 1306 is a large capacity information storage unit typified by a hard disk drive device. An operating system (OS) and a computer program, which is used when the CPU 1301 realizes the function of each unit illustrated in FIGS. 1 to 4, are stored in the external storage device 1306. Further, each image data as a processing object can be stored in the external storage device 1306.

The computer program or data stored in the external storage device 1306 is loaded into the RAM 1302 as appropriate according to the control of the CPU 1301 and processed by the CPU 1301. A network such as a local area network (LAN) or the Internet and other apparatus such as a projection apparatus or a display device can be connected to an I/F 1307, so that the computer can receive and transmit various pieces of information via the I/F 1307. A bus 1308 connects each of the above-described units.

The operation realized by the above-described configuration is performed mainly by the CPU 1301. The processing described with reference to the flowchart described above is controlled by the CPU 1301.

An example of the present invention can be achieved when a storage medium storing code of a computer program that realizes the above-described function is supplied to the system and the system reads out and executes the code of the computer program. In this case, the program code read out from the storage medium itself realizes the function of the above-described exemplary embodiment, and the storage medium which stores the program code constitutes an example of the present invention. Further, a case where an OS or the like, which runs on a computer, executes apart or whole of the actual processing based on an instruction of the program code so that a function of the above-described function is realized is also included in an example of the present invention.

Furthermore, an example of the present invention can be achieved by the following configuration. Specifically, the computer program code read out from the storage medium is written in a memory provided in a function expanding card inserted in a computer or a function expanding unit connected to the computer, and a CPU provided in the function expanding card or the function expanding unit performs the whole or a part of the actual processing based on an instruction from the computer program code to realize the functions of the above-described exemplary embodiment. The above-described configuration is also included in an example of the present invention. When an example of the present invention is applied to the above-described storage medium, the code of the computer program corresponding to the flowchart described above is stored in the storage medium.

A computer readable storage medium as used within in the context of the present invention is limited to storage mediums which are considered patentable subject matter. A non-limiting list of examples of computer readable storage medium is: RAM; ROM; EEPROM; hard drives; CD-ROM; etc. In the context of the present invention a computer readable storage medium is not a transitory form of signal transmission, such as, a propagating electrical or electromagnetic signal.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2011-243941 filed Nov. 7, 2011 and No. 2012-009304 filed Jan. 19, 2012, which are hereby incorporated by reference herein in their entirety.

What is claimed is:

1. An image coding apparatus comprising:
a block division unit configured to divide an input image into a plurality of blocks;
a prediction unit configured to perform prediction using coded pixels to generate prediction errors;
a transformation unit configured to perform orthogonal transform to the prediction errors to generate a transform coefficients;
a quantization matrix generation unit configured to generate quantization matrices that are used to quantize the transform coefficients;
a quantization matrix coding unit configured to code the quantization matrices;
a quantization unit configured to scan the generated transform coefficients and to quantize the transform coefficients using the quantization matrices to generate quantization coefficients; and
a coefficient coding unit configured to code the quantization coefficients,
wherein the quantization matrix coding unit is configured to code a difference between a coefficient to be coded and a coefficient adjacent to the coefficient to be coded, and to use, when coding the difference having a positive value, a coding table that uses a code of a bit number equal to or less than that of a code used to code the difference having a negative value having the same absolute value as the absolute value of the positive value.

2. The image coding apparatus according to claim 1, further comprising a control information generation unit configured to determine, when the quantization matrix coding unit codes the difference between the coefficient to be coded and the coefficient adjacent to the coefficient to be coded and codes the difference having a positive value, whether the coding table that uses a code of a bit number equal to or less than that of a code used to code the difference having a negative value having the same absolute value as the absolute value of the positive value or a different coding table is to be used, and to code an identifier indicating the coding table to be used.

3. An image coding method comprising:
dividing an input image into a plurality of blocks;
performing prediction using coded pixels to generate prediction errors;
performing orthogonal transform to the prediction errors to generate transform coefficients;
generating quantization matrices that are used to quantize the transform coefficients;
coding the quantization matrices;
scanning the generated transform coefficients and quantizing the transform coefficients using the quantization matrices to generate quantization coefficients;
coding the quantization coefficients; and
coding a difference between a coefficient to be coded and a coefficient adjacent to the coefficient to be coded in coding quantization matrices, and using, when coding the difference having a positive value, a coding table that uses a code of a bit number equal to or less than that of a code used to code the difference having a negative value having the same absolute value as the absolute value of the positive value.

4. An image decoding apparatus comprising:
a decoding/separating unit configured to decode header information of an input bit stream and to separate required codes;
a coefficient decoding unit configured to decode quantization coefficients;
a quantization matrix decoding unit configured to decode quantization matrices that are used to inversely quantize the quantization coefficients, and
an inverse quantization unit configured to inversely quantize the decoded quantization coefficients using the decoded quantization matrices to generate transform coefficients;
wherein the quantization matrix decoding unit is configured to decode a difference between a coefficient to be decoded and a coefficient adjacent to the coefficient to be decoded, and to use, when decoding the difference having a positive value, a decoding table that uses a code of a bit number equal to or less than that of a code used to decode the difference having a negative value having the same absolute value as the absolute value of the positive value.

5. An image decoding method comprising:
decoding header information of an input bit stream and separating required codes;
decoding quantization coefficients;
decoding quantization matrices that are used to inversely quantize the quantization coefficients;
inversely quantizing the decoded quantization coefficients using the decoded quantization matrices to generate transform coefficients; and
decoding a difference between a coefficient to be decoded and a coefficient adjacent to the coefficient to be decoded in decoding quantization matrices, and using, when decoding the difference having a positive value, a decoding table that uses a code of a bit number equal to or less than that of a code used to decode the difference having a negative value having the same absolute value as the absolute value of the positive value.

6. An image coding apparatus comprising:
a block division unit configured to divide an input image into a plurality of blocks;
a prediction unit configured to perform prediction using coded pixels to generate prediction errors;
a transformation unit configured to perform orthogonal transform to the prediction errors to generate transform coefficients;
a quantization matrix generation unit configured to generate quantization matrices that is used to quantize the transform coefficients;
a quantization matrix coding unit configured to code the quantization matrices;
a quantization unit configured to scan the generated transform coefficients and to quantize the transform coefficients using the quantization matrices to generate a quantization coefficients; and
a coefficient coding unit configured to code the quantization coefficients,
wherein, when coding a difference value between a coefficient to be coded and a coefficient adjacent to the coefficient to be coded, the quantization matrix coding unit is configured to perform mapping of the difference value to an index having a positive value by using a mapping table used for mapping the difference value to an index having a positive value, and to code the index, and
wherein, regarding the mapping table, an index corresponding to a negative value having the same absolute value as the absolute value of the positive value is always greater than an index corresponding to the positive value, and the mapping table includes at least one positive value greater than an absolute value of a negative value corresponding to an index having a smaller value than an index corresponding to an arbitrary negative value.

7. The image coding apparatus according to claim 6, wherein, when coding the difference value between the coefficient to be coded and the coefficient adjacent to the coefficient to be coded, the quantization matrix coding unit is configured to perform mapping of the difference value to an index having a positive value by using one of a plurality of mapping tables used for mapping the difference value to an index having a positive value, and to code the index and an identifier indicating the selected mapping table, and
wherein, regarding at least one of the plurality of mapping tables, an index corresponding to a negative value having the same absolute value as the absolute value of the positive value is always greater than an index corresponding to the positive value, and at least one of the plurality of mapping tables includes at least one positive value greater than an absolute value of a negative value corresponding to an index having a smaller value than an index corresponding to an arbitrary negative value.

8. The image coding apparatus according to claim 6, wherein the quantization matrix coding unit is configured to further code information representing a difference between an index corresponding to a positive value first occurring and an index corresponding to a negative value first occurring in an order of indices of the mapping table.

9. An image decoding apparatus comprising:
a decoding/separating unit configured to decode header information of an input bit stream and to separate required codes;
a coefficient decoding unit configured to decode quantization coefficients;
a quantization matrix decoding unit configured to decode quantization matrices that are used to inversely quantize the quantization coefficients, and
an inverse quantization unit configured to inversely quantize the decoded quantization coefficients using the decoded quantization matrices to generate transform coefficients;
wherein, when decoding a difference between a coefficient to be decoded and a coefficient adjacent to the coefficient to be decoded, the quantization matrix decoding unit is configured to reproduce an index having a positive value and to generate a difference value by using a mapping table used for mapping the index to the difference value, and
wherein, regarding the mapping table, an index corresponding to a negative value having the same absolute value as the absolute value of the positive value is always greater than an index corresponding to the positive value, and the mapping table includes at least one positive value greater than an absolute value of a negative value corresponding to an index having a smaller value than an index corresponding to an arbitrary negative value.

10. The image decoding apparatus according to claim 9, wherein, when decoding the difference between the coefficient to be decoded and the coefficient adjacent to the coefficient to be decoded, the quantization matrix decoding unit is configured to reproduce an index having a positive value, to decode an identifier used for identifying one of a plurality of mapping tables used for mapping the index to the difference value, and to generate a difference value by using the mapping table selected based on the identifier, and
wherein, regarding at least one of the plurality of mapping tables, an index corresponding to a negative value having the same absolute value as the absolute value of the positive value is always greater than an index corresponding to the positive value, and at least one of the plurality of mapping tables includes at least one positive value greater than an absolute value of a negative value corresponding to an index having a smaller value than an index corresponding to an arbitrary negative value.

11. The image decoding apparatus according to claim 9, wherein the quantization matrix decoding unit is configured to further decode information representing a difference between an index corresponding to a positive value first occurring and an index corresponding to a negative value first occurring in an order of indices of the mapping table.

12. An image coding method comprising:
dividing an input image into a plurality of blocks;
performing prediction using coded pixels to generate prediction errors;
performing orthogonal transform to the prediction errors to generate transform coefficients;
generating quantization matrices that are used to quantize the transform coefficients;
coding the quantization matrices;
scanning the generated transform coefficients and quantizing the transform coefficients using the quantization matrices to generate quantization coefficients;
coding the quantization coefficients; and
performing, when coding a difference value between a coefficient to be coded and a coefficient adjacent to the coefficient to be coded in coding quantization matrices, mapping of the difference value to an index having a positive value by using a mapping table used for mapping the difference value to an index having a positive value, and coding the index,
wherein, regarding the mapping table, an index corresponding to a negative value having the same absolute value as the absolute value of the positive value is always greater than an index corresponding to the positive value, and the mapping table includes at least one positive value greater than an absolute value of a negative value corresponding to an index having a smaller value than an index corresponding to an arbitrary negative value.

13. An image decoding method comprising:
decoding header information of an input bit stream and separating required codes;
decoding quantization coefficients;
decoding quantization matrices that are used to inversely quantize the quantization coefficients;
inversely quantizing the decoded quantization coefficients using the decoded quantization matrices to generate transform coefficients; and
reproducing, when decoding a difference between a coefficient to be decoded and a coefficient adjacent to the coefficient to be decoded, an index having a positive value and generating a difference value by using a mapping table used for mapping the index to the difference value,
wherein, regarding the mapping table, an index corresponding to a negative value having the same absolute value as the absolute value of the positive value is always greater than an index corresponding to the positive value, and the mapping table includes at least one positive value greater than an absolute value of a negative value corresponding to an index having a smaller value than an index corresponding to an arbitrary negative value.

14. A computer-readable storage medium storing a program that causes a computer to function as the image coding apparatus according to claim 1.

15. A computer-readable storage medium storing a program that causes a computer to function as the image coding apparatus according to claim 6.

16. A computer-readable storage medium storing a program that causes a computer to function as the image decoding apparatus according to claim 4.

17. A computer-readable storage medium storing a program that causes a computer to function as the image decoding apparatus according to claim 9.
